(19) United States
(12) Patent Application Publication
(10) Pub. No.: US 2012/0073982 A1
(43) Pub. Date: Mar. 29, 2012

(54) ELECTROLYTIC CONVERSION OF WASTE WATER TO POTABLE WATER

(76) Inventor: John M. Lambie, Portland, OR (US)

(21) Appl. No.: 12/889,198

(22) Filed: Sep. 23, 2010

(51) Int. Cl. C02F 1/461; C25B 1/04; H01M 8/06; C25B 9/00

(52) U.S. Cl. 205/343; 204/270

(57) ABSTRACT

A method for converting waste water into potable water using power from an electrical grid. The method comprises flowing the waste water through an electrolysis cell coupled to the grid, and, when power availability on the grid is above an upper threshold, biasing the electrolysis cell to form hydrogen. Hydrogen evolved in the electrolysis is then provided as fuel to one or more fuel cells. When the power availability on the grid is below a lower threshold, electric current and potable water are drawn from the one or more fuel cells.

### TECHNICAL FIELD

This application relates to the field of water treatment, and more particularly, to converting waste water into potable water.

### BACKGROUND

Various alternative energy sources—solar, wind, wave, and tidal—are intermittent by nature. Demand for energy is often present when these intermittent alternative energy sources are not producing. Unfortunately, large-scale storage and release of electrical energy presents numerous cost and efficiency challenges, and suitable technologies have yet to developed which would enable power producers to store energy to service later demand. As a result, the potential for widespread use of clean energy from alternative energy sources remains unfulfilled.

### SUMMARY

One embodiment of this disclosure provides a method for converting waste water into potable water using power from an electrical grid; the grid is configured to receive power from an intermittent power source. The method comprises flowing the waste water through an electrolysis cell coupled to the grid, and, when power availability on the grid is above an upper threshold, biasing the electrolysis cell to form hydrogen. Hydrogen evolved in the electrolysis is then provided as fuel to one or more fuel cells. When the power availability on the grid is below a lower threshold, electric current and potable water are drawn from the one or more fuel cells.

It will be understood that the summary above is provided to introduce in simplified form a selection of concepts that are further described in the detailed description, which follows. It is not meant to identify key or essential features of the claimed subject matter, the scope of which is defined by the claims that follow the detailed description. Further, the claimed subject matter is not limited to implementations that solve any disadvantages noted herein.

### BRIEF DESCRIPTION OF THE DRAWINGS

FIG. 1 schematically shows an example system for converting waste water into potable water in accordance with an embodiment of this disclosure.

FIGS. 2 and 3 illustrate an example methods for converting waste water into potable water in accordance with different embodiments of this disclosure.

FIG. 4 illustrates an example method for drawing electric current from one or more fuel cells in accordance with an embodiment of this disclosure.

### DETAILED DESCRIPTION

The subject matter of this disclosure is now described by example and with reference to the illustrated embodiments listed above. Components, process steps, and other elements that may be substantially the same in one or more embodiments are identified coordinately and are described with minimal repetition. It will be noted, however, that elements identified coordinately may also differ to some degree. It will be further noted that the drawing figures included in this disclosure are schematic and generally not drawn to scale. Rather, the various drawing scales, aspect ratios, and numbers of components shown in the figures may be purposely distorted to make certain features or relationships easier to see.

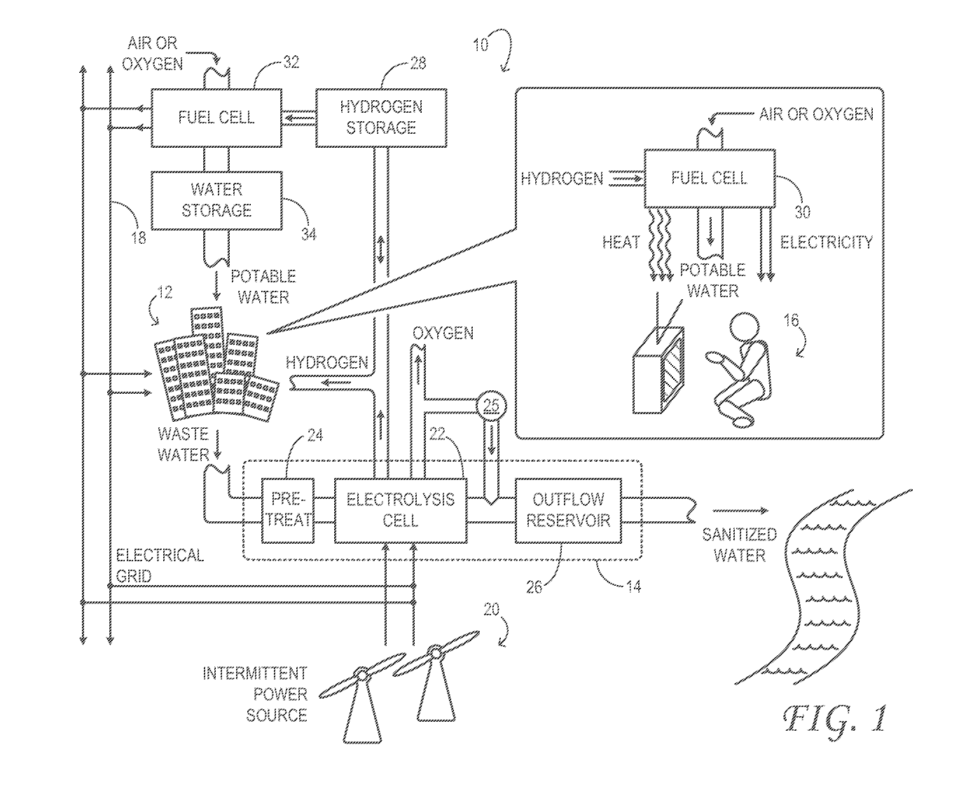

FIG. 1 shows an example system 10 for converting waste water into potable water in one embodiment. The system may be arranged in any suitable municipal, residential, and/or commercial area. Accordingly, FIG. 1 shows community 12, which consumes potable water and discharges waste water. In the embodiment shown in FIG. 1, the waste water from the community is conducted to water-treatment facility 14.

In one embodiment, the waste water discharged by the community may include storm-drain outflow. In another embodiment, the waste water may include treated sewage. In yet another embodiment, the waste water may include untreated sewage. Accordingly, water-treatment facility 14 may be configured to receive and treat any of these kinds of waste water, or any combination thereof.

Community 12 includes a plurality of resource consumers, such as resource consumer 16. The resource consumers within the community may consume heat and electricity in addition to potable water. Accordingly, FIG. 1 shows electrical grid 18, configured to supply electric power to the community. The electrical grid is also configured to receive at least some electric power from intermittent power source 20. In one embodiment, the intermittent power source may comprise a solar power source—e.g., a bank of photovoltaic cells. In another embodiment, the intermittent power source may comprise a wind power source, such as a wind farm. In yet another embodiment, the intermittent power source may comprise a wave power source or a tidal power source. These power sources are intermittent by nature. As such, it may be difficult or impossible to correlate the power output of the intermittent power source with the demand for power on the electrical grid. System 10 is therefore arranged so that excess power from the intermittent power source is used to make potable water—a valuable, readily storable resource.

Continuing in FIG. 1, system 10 includes flow-through electrolysis cell 22 arranged within water-treatment facility 14. The electrolysis cell is configured to receive a portion of the waste water from the community and to electrolyze some of the waste water received into hydrogen and oxygen. The remainder of the waste water received may be sanitized by virtue of the electrolysis conditions within the electrolysis cell. Such conditions may include a high concentration of dissolved oxygen, a high concentration of dissolved hydrogen, a high concentration of chlorine, hypochlorous acid, and/or elevated temperatures. Any or all of these conditions may have a significant biocidal or bioinhibitory effect, making the water suitable for discharge into a body of water—e.g., a river, lake, bay, wetlands, or ocean.

Electrolysis cell 22 includes at least one cathode where hydrogen is evolved and at least one anode where oxygen-containing anode off gas is evolved. The anode and the cathode may be biased with power from electrical grid 18 via suitable electronic componentry, such that positive electric current is supplied to the anode and drawn from the cathode. The electrolysis cell may also include at least one polymer-electrolyte membrane (PEM) arranged between the anode and the cathode. To avoid admittance of materials that could degrade the anode, cathode, PEM, or other components of the electrolysis cell, pretreatment stage 24 is included upstream of the electrolysis cell. The pretreatment stage may comprise a settling tank, a filtration stage, and/or an ion exchange bed, for example.

In one particular embodiment, some or all of the anode off gas released from electrolysis cell 22 may be pressurized via pump 25 and readmitted to the outflow from the electrolysis cell. The anode off gas may be dispersed (e.g., bubbled) into the outflow to minimize the footprint and/or odor from the final stages of water treatment. Compared to atmospheric aeration of the outflow, readmittance of the anode off gas will expose the outflow to a much greater mole fraction of oxygen, even when minor amounts of chlorine or other oxidation products are also present in the off gas. As shown in FIG. 1, the sanitized outflow from the electrolysis cell may be admitted to outflow reservoir 26 prior to final discharge.

Continuing in FIG. 1, the hydrogen evolved in electrolysis cell 22 flows to hydrogen-storage reservoir 28 and may also be distributed within community 12 as fuel. More specifically, the hydrogen may be distributed to local fuel cell 30. Within the community, one or more resource consumers may draw at least some electric power from the local fuel cell. The local fuel cell may be a hydrogen-air fuel cell comprising at least one anode and at least one cathode. In one embodiment, the local fuel cell may provide heat and potable water to the one or more resource consumers, in addition to electric power. In the embodiments contemplated herein, a plurality of local fuel cells may be distributed within the community. These fuel cells may supply electric power, heat, and/or potable water locally to a plurality of resource consumers.

From hydrogen-storage reservoir 28, hydrogen is also supplied to community fuel cell 32. The community fuel cell may have a much larger capacity than local fuel cell 30. The community fuel cell may be configured, via appropriate electronic componentry, to supply electric power to electrical grid 18. Due to its larger capacity, the community fuel cell may generate a significant outflow of potable water. Accordingly, the potable water discharged from the community fuel cell is routed to water-storage reservoir 34, where at least some of the potable water supply for community 12 is stored.

The configurations described above enable various methods for converting waste water into potable water. Accordingly, some such methods are now described, by way of example, with continued reference to above configurations. It will be understood, however, that the methods here described, and others fully within the scope of this disclosure, may be enabled via other configurations as well.

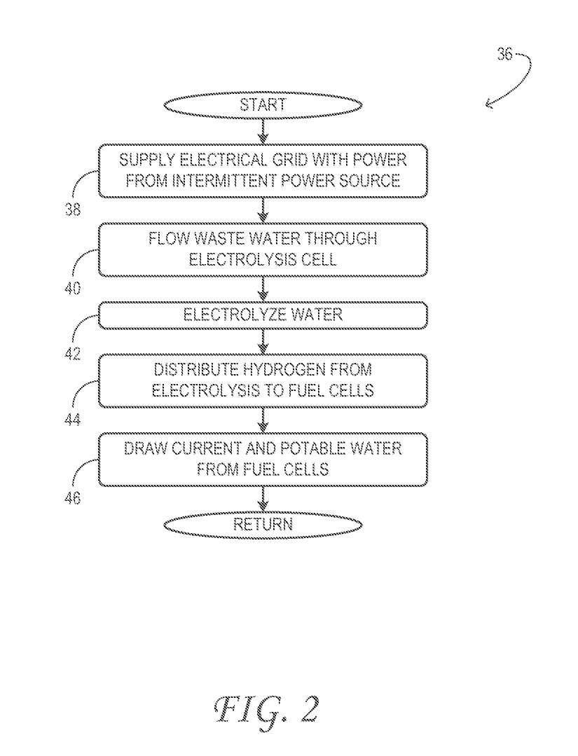

FIG. 2 illustrates an example method 36 for converting waste water into potable water in one embodiment. At 38 an intermittent power source is used to supply at least some power to an electrical grid that services a community. At 40 waste water—sewage or storm-drain outflow, for example—flows through an electrolysis cell as described above. In one embodiment, a level of contamination in the waste water may be reduced before flowing through the electrolysis cell. In the electrolysis cell, some of the waste water, at 42, is electrolyzed using power from the electrical grid, to form hydrogen and oxygen. Due to the electrolysis conditions—as noted above—the portion of the waste water not electrolyzed into hydrogen and oxygen may be sanitized within the electrolysis cell. On discharge from the electrolysis cell, this water may be suitable for discharge into a body of water. At 44 hydrogen evolved in the electrolysis cell flows and is distributed to one or more fuel cells—community and/or local fuel cells, as noted hereinabove. In one embodiment, at least some of the oxygen evolved in the electrolysis cell may be distributed to the one or more fuel cells. In another embodiment, the oxygen is discarded, and air is supplied to the fuel cells. In another embodiment, at least some oxygen is neither supplied to the fuel cells nor discarded, but is pressurized and readmitted to the outflow of unconverted waste water from the electrolysis cell, as described hereinabove. At 46 electric current and potable water are drawn from the one or more fuel cells, as further described hereinafter, and the method returns. In one embodiment, the electric current drawn from the one or more fuel cells may be applied as bias to the electrolysis cell in order to offset the energy used to drive the electrolysis.

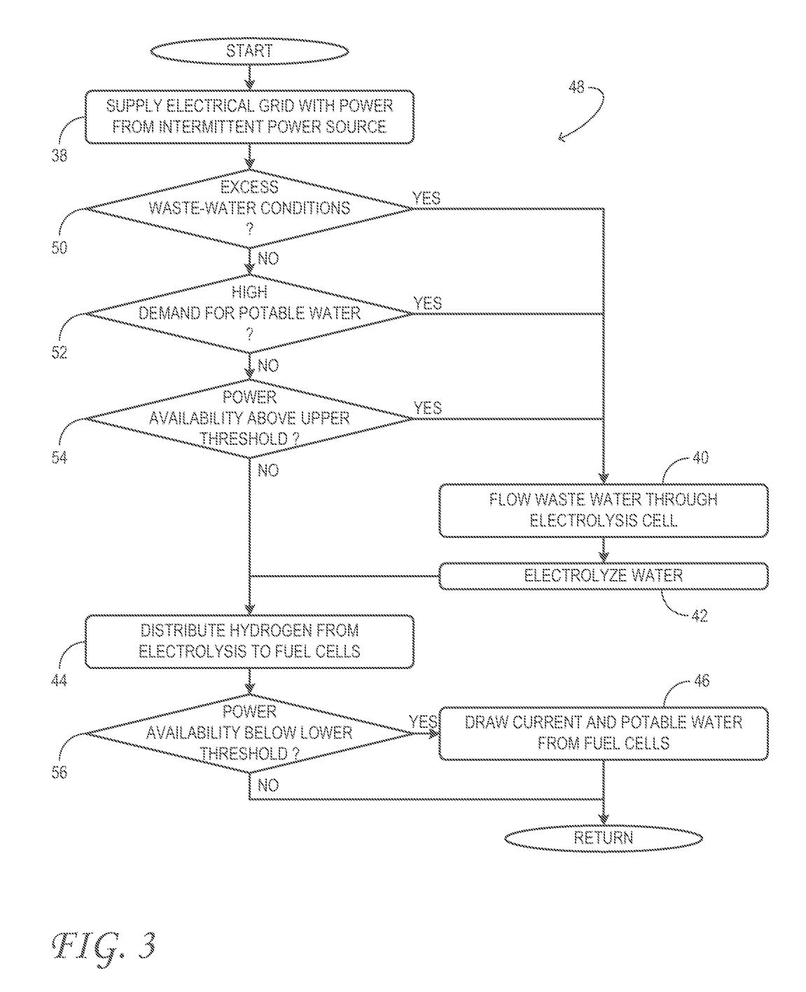

FIG. 3 illustrates another example method 48 for converting waste water into potable water in one embodiment. At 38 an intermittent power source is used to supply at least some power to an electrical grid that services a community. At 50 it is determined whether excess waste-water conditions (e.g., flood conditions) are apparent. In one embodiment, the excess waste-water condition may correspond to a level of waste water rising above a threshold. If excess waste-water conditions are not apparent, then the method advances to 52, where the demand for potable water is assessed. In one embodiment, the demand for potable water may be compared to a threshold. If the demand for potable water is not high (e.g., if the demand is below the threshold), then the method advances to 54, where an availability of power on the electrical grid is assessed. If the power availability is above an upper threshold, or if the demand for potable water is high, or if excess waste-water conditions are apparent, then the method advances to 40, where waste water flows through the electrolysis cell, and to 42, where water in the electrolysis cell is electrolyzed. Accordingly, converting waste water to hydrogen and oxygen may be coordinated with conditions where the level of the waste water is in excess, where there is a high demand for potable water, or where ample power is available on the electrical grid.

After 42, or if it is determined at 54 that the power availability is not above the upper threshold, then method 48 advances to 44. At 44 hydrogen from the electrolysis cell flows and is distributed to one or more fuel cells. At 56 it is determined whether the power availability on the electrical grid is below a lower threshold. If the power availability is below the lower threshold, then the method advances to 46, where electric current and potable water are drawn from the one or more fuel cells, as further described hereinafter. Accordingly, the conversion of stored chemical energy back into electrical energy may be coordinated to conditions where power on the electrical grid is below a threshold. Furthermore, by virtue of decision block 52, the conversion of waste water to potable water may be coordinated with a high demand for or low availability of potable water. Then, from 56 or 46, method 48 returns.

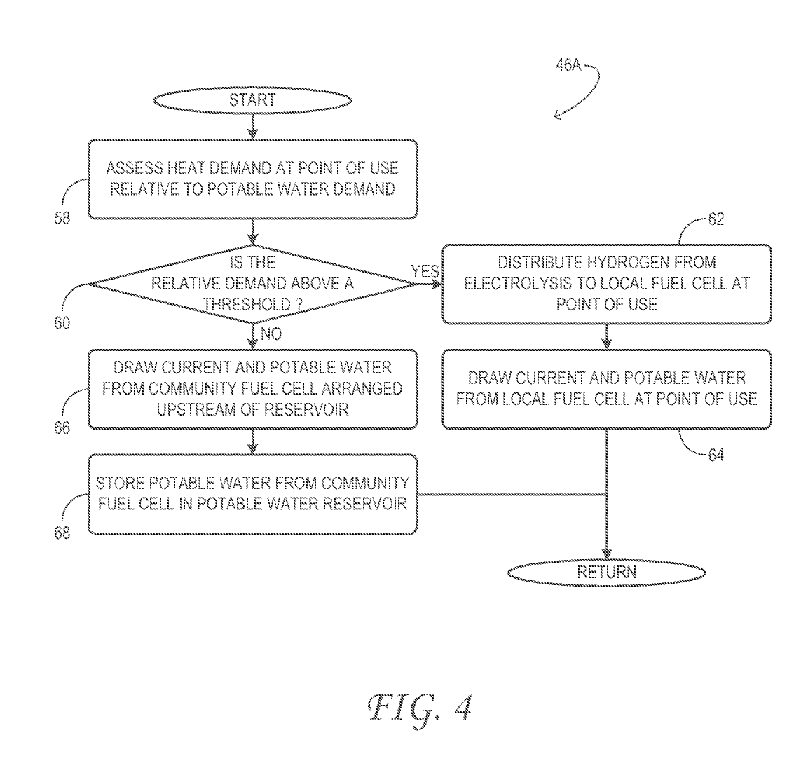

FIG. 4 illustrates an example method 46A for drawing electric current from a fuel cell in one embodiment. Method 46A may be enacted at 46 of method 48, for example. This method illustrates how, during a first condition, electric current may be drawn from a community fuel cell arranged upstream of a potable-water reservoir. The method further illustrates how, during a second condition, electric current may be drawn from a local fuel cell arranged to provide heat and electricity at a point of use.

At 58 the demand for heat at a point of use relative to a demand for potable water in the community is assessed. At 60 it is determined whether the relative demand thus assessed is above a threshold. If the relative demand is above the threshold, then the method advances to 62, where hydrogen from the electrolysis cell is distributed to a local fuel cell at the point of use. The method then advances to 64, where electric current and potable water are drawn from the local fuel cell at point of use. Under these conditions, a demand for heat at the point of use may be above a heat-demand threshold, or, a demand for potable water may be below a potable-water demand threshold.

However, if the relative demand is not above the threshold, then the method advances to 66, where electric current and potable water are drawn from a community fuel cell arranged upstream of a potable-water reservoir. The method then advances to 68, where potable water from the community fuel cell is stored in the potable water reservoir. Under these conditions, a demand for potable water in the community may be above a potable-water demand threshold, or, a demand for heat at the point of use may be below a heat-demand threshold. From 64 or 68, method 46A returns.

It will be understood that the example control and estimation routines disclosed herein may be used with various system configurations. These routines may represent one or more different processing strategies such as event-driven, interrupt-driven, multi-tasking, multi-threading, and the like. As such, the disclosed process steps (operations, functions, and/or acts) may represent code to be programmed into computer readable storage medium in an electronic control system.

It will be understood that some of the process steps described and/or illustrated herein may in some embodiments be omitted without departing from the scope of this disclosure. Likewise, the indicated sequence of the process steps may not always be required to achieve the intended results, but is provided for ease of illustration and description. One or more of the illustrated actions, functions, or operations may be performed repeatedly, depending on the particular strategy being used.

Finally, it will be understood that the articles, systems, and methods described hereinabove are embodiments of this disclosure—non-limiting examples for which numerous variations and extensions are contemplated as well. Accordingly, this disclosure includes all novel and non-obvious combinations and sub-combinations of the articles, systems, and methods disclosed herein, as well as any and all equivalents thereof.

1. A method for converting waste water into potable water using power from an electrical grid, the method comprising:
flowing the waste water through an electrolysis cell coupled to the electrical grid, the electrical grid configured to receive power from an intermittent power source;
when a power availability on the grid is above an upper threshold, biasing the electrolysis cell to form hydrogen;
distributing the hydrogen to one or more fuel cells; and
when the power availability on the grid is below a lower threshold, drawing electric current and potable water from the one or more fuel cells.

2. The method of claim 1, wherein the intermittent power source comprises one or more of a solar power source, a wind power source, a wave power source, and a tidal power source.

3. The method of claim 1, wherein the waste water comprises one or more of storm-drain outflow, treated sewage, and untreated sewage.

4. The method of claim 1 further comprising biasing the electrolysis cell to form hydrogen when a level of the waste water is above a threshold.

5. The method of claim 1 further comprising drawing electric current and potable water from the one or more fuel cells when a potable-water availability is below a threshold.

6. The method of claim 1, wherein drawing electric current and potable water from the one or more fuel cells comprises:
during a first condition, drawing electric current from a fuel cell arranged upstream of a potable-water reservoir; and
during a second condition, drawing electric current from a fuel cell arranged to provide heat and electricity at a point of use.

7. The method of claim 6, wherein a demand for heat at the point of use is below a threshold during the first condition and above the threshold during the second condition.

8. The method of claim 6, wherein a demand for potable water is above a threshold during the first condition and below the threshold during the second condition.

9. The method of claim 6 further comprising storing the potable water in the reservoir during the first condition.

10. The method of claim 6, further comprising distributing the hydrogen to the fuel cell arranged to provide heat at the point of use during the second condition.

11. The method of claim 1 further comprising reducing a level of contamination in the waste water before flowing the waste water through the electrolysis cell.

12. The method of claim 1 further comprising distributing oxygen to the one or more fuel cells.

13. The method of claim 1 further comprising sanitizing within the electrolysis cell and discharging from the electrolysis cell a portion of the waste water not converted to potable water.

14. The method of claim 14 further comprising pressurizing and readmiting an anode off gas from the electrolysis cell into the portion of the waste water not converted to potable water.

15. The method of claim 1, wherein the electric current drawn from the one or more fuel cells is applied as bias to the electrolysis cell.

16. A method for converting waste water into potable water using power from an electrical grid, the method comprising:
during a first condition, drawing electric current from a first fuel cell arranged upstream of a potable-water reservoir;
during a second condition, drawing electric current from a second fuel cell arranged to provide heat and electricity at a point of use;
flowing the waste water through an electrolysis cell coupled to the electrical grid, the electrical grid configured to receive power from an intermittent power source;
flowing the waste water through an electrolysis cell;
during a third condition, biasing the electrolysis cell with power from the electrical grid to form hydrogen;
distributing the hydrogen to the first or second fuel cells.

17. The method of claim 16 further comprising drawing potable water from the fuel cell arranged upstream of the potable water reservoir during the first condition.

18. The method of claim 16, wherein a demand for potable water relative to a demand for heat at the point of use exceeds a threshold during the first condition.

19. The method of claim 16, wherein a demand for potable water relative to a demand for heat at the point of use is below a threshold during the second condition.

20. A water-treatment system comprising:
an electrolysis cell configured to receive waste water, discharge sanitized water, and evolve hydrogen, the cell biased with power from an electrical grid, the grid configured to receive power from an intermittent power source; and
a fuel cell configured to receive the hydrogen, receive also oxygen, and discharge potable water.
